(19) United States
(12) Patent Application Publication
(10) Pub. No.: US 2024/0025094 A1
(43) Pub. Date: Jan. 25, 2024

(54) METHODS, SYSTEMS AND COMPUTER PROGRAM PRODUCTS FOR PRODUCING POLYURETHANE FOAM PRODUCTS USING OPTICAL AND INFRARED IMAGING

(71) Applicant: Covestro LLC, Pittsburgh, PA (US)

(72) Inventors: Devin W. Ulam, Pittsburgh, PA (US); Scott M. Cloherty, Canonsburg, PA (US); Steven G. Owens, Sewickley, PA (US); David D. Steppan, Gibsonia, PA (US); Susan B. McVey, Houston, PA (US)

(21) Appl. No.: 17/766,370

(22) PCT Filed: Oct. 6, 2020
(86) PCT No.: PCT/US2020/054355

§ 371 Date: Apr. 4, 2022

Related U.S. Application Data
(60) Provisional application No. 62/912,820, filed on Oct. 9, 2019.

(51) Int. Cl. B29C 44/60; A62C 3/00; A62C 37/36

(52) U.S. Cl. CPC B29C 44/60; A62C 3/002; A62C 37/36; B29C 2793/009; B29K 2075/00

(57) ABSTRACT

Disclosed are methods, systems and computer program products for producing polyurethane foam, and then imaging the polyurethane foam at or just after the outlets while the foam is being produced, above the surface of the foam at an angle greater than zero to less than degrees relative to the surface of the foam, or after the foam is cut but before it has cooled to room temperature, using an infrared or an optical imaging device, to capture an image of the polyurethane foam, and determining, based on the captured image, if a defect that requires correction exists in the polyurethane foam; and optionally, in response to determining that a defect requiring correction exists, modifying a process parameter in producing the polyurethane foam.

### FIELD

The present invention is directed to, among other things, methods, systems and computer program products for producing polyurethane foam products using optical and infrared imaging.

### BACKGROUND

Flexible slab stock polyurethane foam is used in furniture, mattresses and a variety of consumer products. In producing slab stock polyurethane foam, it is important to maintain good quality control, so the foam products will function as expected. In addition, like many processes, it is important to minimize waste and downtime as producers strive to utilize their assets and raw materials to a more efficient manner.

The raw materials that are used in creating slab stock polyurethane foam are fluids that are designed to solidify quickly into flexible foam structures. If the process for their manufacture is not operating as designed, the slab stock polyurethane foam may be created with irregular foam density, or have cracks, tears or large bubbles inside the foam, which may affect the appearance and performance of the foam. While quality control process may identify some foam products that have such defects, those products may have to be sold at a lower price or scrapped entirely. Meanwhile, the process for producing slab stock polyurethane foam may have to be shut down to fix whatever caused the quality problem.

It would be desirable to improve the methods of producing slab stock polyurethane foam, to reduce the amount of waste or substandard products, to reduce the amount of downtime in fixing processes that produce slab stock polyurethane foam, and to improve the utilization of raw materials and the assets used to create such foam products.

### SUMMARY OF THE INVENTION

In one embodiment, a method, system or computer program product for producing polyurethane foam is disclosed, comprising: depositing a foam producing mixture from outlets onto a trough or a conveyor; producing the polyurethane foam having a top surface, from the foam producing mixture via an exothermic reaction; cutting the polyurethane foam; imaging the polyurethane foam (i) at or just after the outlets while the foam is being produced, (ii) above the top surface of the foam at an angle greater than zero to less than 90 degrees relative to the surface of the foam, or (iii) after the foam is cut but before it has cooled to room temperature, using an infrared or an optical imaging device, to capture an image of the polyurethane foam; receiving a first signal comprising the captured image from the imaging device to a computing device; determining, based on the captured image, if a defect that requires correction exists in the polyurethane foam; and optionally, in response to determining that a defect requiring correction exists, modifying a process parameter in producing the polyurethane foam.

In another embodiment, the foam producing mixture comprises a polyisocyanate, an isocyanate-reactive component and a blowing agent.

In a different embodiment, the imaging is at both (i) the outlets while the foam is being produced, and (ii) above the surface of the foam at an angle greater than zero to less than degrees relative to the surface of the foam.

In another different embodiment, the imaging is (ii) above the surface of the foam at an angle of 30-60 degrees relative to the surface of the foam.

In yet another embodiment, the infrared or optical imaging device is an infrared camera.

In still another embodiment, the defect is selected from the group consisting of (i) a bubble, tear, hole or other void has appeared, (ii) the predicted foam density is too high, (iii) the predicted foam density is too low, (iv) the predicted firmness or compressive strength is too high, (v) the predicted firmness or compressive strength is too low, (vi) the raw material utilization is not optimal, and (vii) a portion of the bun has not developed as anticipated.

In an embodiment not yet disclosed, the process parameter is selected from the group consisting of flow from an outlet, flow of raw material to an outlet, notifying a process operator, speed of producing the polyurethane foam, speed of a conveyor, components of the foam producing mixture, amounts of a component of the foam producing mixture and halt production.

In another embodiment, the method, system or computer program product further comprises: determining the polyurethane foam does not meet quality standards, based on the captured image of the polyurethane foam; cutting the polyurethane foam; and separating the cut polyurethane foam that does not meet quality standards.

In still another embodiment, the method, system or computer program product further comprises: displaying on a user interface at least one of a process parameter and a visual representation of the captured image; receiving on the user interface an input to change at least one process parameter; and altering the at least one process parameter in response to the input from the user interface.

In a different embodiment, the method, system or computer program product further comprises: receiving one or more alternative polyurethane foam product specifications; determining if, by altering at least one process parameter, the alternative polyurethane foam product can be produced according to the product specifications; and altering at least one process parameter to produce the alternative polyurethane foam product according to the product specifications.

In yet another embodiment, in response to determining that a defect requiring correction has appeared, modifying a process parameter in producing the polyurethane foam, comprises: receiving, with at least one processor, at least one of: (a) data associated with a previously-stored solution to correcting the defect that has appeared in the polyurethane foam; or (b) data from a predictive model used to generate a solution to correcting the defect that has appeared in a polyurethane foam; and altering at least one process parameter in response to the data received by the at least one processor.

In an embodiment different from the above, the method, system or computer program product further comprises: receiving a second signal comprising a captured image from the imaging device to a computing device, after the process parameter has been modified; and storing data associated with the first and second signals, and the modification of the process parameter in producing polyurethane foam, to the computing device.

In another different embodiment, the method, system or computer program product further comprises: storing the polyurethane foam at a location with either sprinklers or a fire suppression system; monitoring the temperature of the polyurethane foam that is being stored by an IR camera; and in response to detecting an elevated temperature of the polyurethane foam, activating the sprinklers or the fire suppression system.

### BRIEF DESCRIPTION OF THE DRAWINGS

FIG. 1 is a schematic view for a process analyzer and controller; and

FIG. 2 is a step diagram for a method for analyzing and controlling a process to make foam bun, after a problem has been detected.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant reserves the right to amend this specification to expressly recite any subject matter, or portion thereof, incorporated by reference herein.

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

As used herein, the term “computing device” may refer to one or more electronic devices that are configured to directly or indirectly communicate with or over one or more networks. The computing device may be a mobile device. As an example, a mobile device may include a cellular phone (e.g., a smartphone or standard cellular phone), a portable computer (e.g., laptop computer or tablet computer), a wearable device (e.g., watches, glasses, lenses), a personal digital assistant (PDA), and/or other like devices. In other non-limiting embodiments, the computing device may be a desktop computer or other non-mobile computer. Furthermore, the term “computer” may refer to any computing device that includes the necessary components to receive, process, and output data, and normally includes a processor, a memory, an input device, and a network interface. While a computer may further include a display, a display is not required for all embodiments. An “interface” refers to a generated display, such as one or more graphical user interfaces (GUIs) with which a user may interact, either directly or indirectly (e.g., through a keyboard, mouse, etc.). Further, one or more computers, e.g., servers, or other computerized devices, directly or indirectly communicating in the network environment may constitute a “system”.

Equivalent weights and molecular weights given herein in Daltons (Da) are number average equivalent weights and number average molecular weights respectively, unless indicated otherwise. The nominal molecular weight is the nominal number average equivalent weight multiplied by the starter functionality. The nominal hydroxyl number equals 56,100 divided by the nominal equivalent weight.

As used herein, the term “nominal functionality” refers to the functionality of a polyether polyol which is based solely on the functionality of the starter compound or initiator used in preparing the polyether polyol. The nominal functionality is typically used to describe the functionality of a specific compound.

As used herein, the term “average functionality” refers to the average number of reactive groups (e.g. hydroxyl, amine, etc.) which are present per molecule of the polyether polyol or polyether polyol blend being described. This term is typically used when either a polyether polyol is prepared from two or more starter compounds or initiators that have different functionalities and/or when a blend of polyether polyols is used in which the individual polyether polyols have different functionalities.

Isocyanate index is the relative stoichiometric amount of isocyanate functional groups necessary to react with the isocyanate reactive groups present in the overall foam formulation. It is expressed as a percentage in this application; thus equal stoichiometric amounts of isocyanate functional groups and isocyanate reactive functional groups in the formulation provide an isocyanate index of 100%.

As used herein, the term “viscoelastic foam” or “viscoelastic polyurethane foam” refers to low-resilience polyurethane foam and is commonly referred to as memory foam. These foams typically provide uniform support of any weight placed on the foam targeted to relieve pressure points, and the foam recovers slowly to its original shape once the weight is removed. These foams are mainly used for bedding, pillows, etc.

A polyurethane foam composition that may be used in association with the present invention may comprise the reaction product of:
(1) toluene diisocyanate, with
(2) an isocyanate-reactive component comprising:
   (a) from 20 to 100% by weight, based on 100% by weight of components (2)(a) and (2)(b), of a polyol blend having a hydroxyl number of from about 56 to about 250, an average functionality of greater than about 2, and which comprises:
      (i) one or more monofunctional polyethers having a hydroxyl number of less than or equal to 56, and containing less than or equal to 20% by weight of copolymerized oxyethylene, based on the total weight of monofunctional polyether (a)(i),
      (ii) one or more polyether polyols having a hydroxyl number of from 47 to 300, a nominal functionality of 2, and containing from about 5 to about 45% by weight of copolymerized oxyethylene, based on the total weight of polyether polyol (a)(ii), and
      (iii) one or more polyether polyols having a hydroxyl number of about 47 to about 300, a nominal functionality of greater than 2 to about 8, and containing from about 5 to about 45% by weight of copolymerized oxyethylene, based on the total weight of polyether polyol (a)(iii);
   wherein (a) the polyol blend comprises 20 to 50% by weight of (i) the one or more monofunctional polyethers and the balance of (a) comprises components (ii) and (iii) in which from 10 to 90% by weight of the balance comprises component (ii) and from 90 to 10% by weight of the balance comprises component (iii); and
   (b) up to 80% by weight, based on 100% by weight of components (2)(a) and (2)(b), of one or more polyether polyols having an average functionality of 2 to 8, a hydroxyl number of 20 to 300 and comprising at least 50% by weight of copolymerized oxyethylene, based on the total weight of the polyether polyol (2)(b);
in the presence of:
(3) one or more blowing agents;
(4) one or more catalysts; and
(5) one or more surfactants;
wherein the quantity, OH number and functionality of components (2)(a)(i), (2)(a)(ii) and (2)(a)(iii) are selected such that the resultant viscoelastic foam has a storage modulus ratio at to 30° C. of less than or equal to 5 to about 1, and a Tg of less than 20° C. as measured by tan delta, over a density of from about 1.0 to about 6.0 at an NCO Index of greater than 95 to about 110.

The polyol blend (a) has an overall hydroxyl number of from about 56 to about 250 and an average functionality of greater than about 2. This polyol blend may have a hydroxyl number of at least about 56, or at least about 70, or at least about 80. This polyol blend may also have a hydroxyl number of about 250 or less, or less than 120, or about 118 or less. The in-situ formed polyol blend (a) may have a hydroxyl number ranging between any combination of these upper and lower values, inclusive, such as from at least about 56 to about 250 or less, or from at least about 70 to less than 120, or from at least about 80 to less than or equal to 118.

Polyol blend (a) also typically has an average functionality of greater than about 2. This polyol blend may have an average functionality of greater than about 2, or at least about 2.1. The average functionality of this polyol blend may also be about 6 or less, or about 4 or less. The polyol blend (a) may have an average functionality ranging between any combination of these upper and lower values, inclusive, such as greater than about 2 to about 6 or less, or at least about 2.1 to about 4 or less.

Suitable (2) isocyanate-reactive components for the viscoelastic polyurethane foams and process of preparing the viscoelastic foams comprise:
(a) from 20 to 100% by weight, based on 100% by weight of components (2)(a) and (2)(b), of a polyol blend having a hydroxyl number of from about 56 to about 250, an average functionality greater than about 2, and comprising:
   (i) one or more monofunctional polyethers having a hydroxyl number of less than or equal to 56, and containing less than or equal to 20% by weight of copolymerized oxyethylene, based on 100% by weight of (a)(i);
   (ii) one or more polyether polyols having a hydroxyl number of from 47 to 300, a nominal functionality of 2, and containing from about 5 to about 45% of copolymerized oxyethylene, based on the total weight of the polyether polyol (a)(ii); and
   (iii) one or more polyether polyols having a hydroxyl number of about 47 to about 300, an nominal functionality of greater than 2 to about 8, and containing from about 5 to about 45% by weight of copolymerized oxyethylene, based on the total weight of the polyether polyol (a)(iii);
   wherein (2)(a) the polyol blend comprises 20 to 50% by weight of (i) the one or more monofunctional polyethers and the balance of (a) comprises components (ii) and (iii) in which from 10 to 90% by weight of the balance comprises component (ii) and from 90 to 10% of the balance comprises component (iii); and
(b) up to 80% by weight, based on 100% by weight of components (2)(a) and (2)(b), of one or more polyether polyols having an average functionality of 2 to 8, a hydroxyl number of 20 to 300 and comprising at least 50% of copolymerized oxyethylene, based on the total weight of the polyether polyol (2)(b).

In another embodiment, the relative amounts of (a) and (b) are 20 to 100% by weight of (a) and up to 80% by weight of (b), or from 85 to 99% by weight of (a) and from 1 to 15% by weight of (b).

Suitable monofunctional polyethers for component (a)(i) include those monols having a hydroxyl number of less than or equal to 56, or of less than or equal to 28.

Suitable starters for (a)(i) include polyoxyalkylene monols formed by addition of multiple equivalents of epoxide to low molecular weight monofunctional starters such as, for example, methanol, ethanol, phenols, allyl alcohol, longer chain alcohols, etc., and mixtures thereof. Examples of suitable longer chain alcohols include C12, C13, C14 and/or C15 monols, which may be used individually or as mixtures. Suitable epoxides can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes, and many more. Suitable monofunctional starters can also be made, for example, by first producing a diol or triol and then converting all but one of the remaining hydroxyl groups to an ether, ester or other non-reactive group. Suitable monofunctional starters include those monols described in, for example, U.S. Pat. Nos. 6,391,935 and 6,821,308, the disclosures of which are hereby incorporated by reference.

In one embodiment, the polyoxyalkylene monol starter comprises a polyoxypropylene monol having a hydroxyl number of less than or equal to 56. These compounds facilitate DMC catalyzed addition of epoxide and provide good build ratios for the production of polyol blends (a).

The monofunctional polyethers may also be characterized in one embodiment as containing up to about 20% by weight of copolymerized oxyethylene, based on the total weight of the monofunctional polyether. This weight percentage includes the initiator or starter and all of the added epoxide(s). These monofunctional polyethers may contain less than or equal to about 20% by weight, or less than or equal to about 15% by weight, or less than or equal to about 10% by weight, based on 100% by weight of the monofunctional polyether, of copolymerized oxyethylene. These monofunctional polyethers may also contain more than 0%, or at least about 2% or at least about 5%, based on the total weight of the monofunctional polyether, of copolymerized oxyethylene. The amount of copolymerized oxyethylene present in the monofunctional polyethers may vary between any combination of these upper and lower values, inclusive, such as, of more than 0% to less than or equal to about 20%, or at least about 2% to less than or equal to about 15%, or at least about 5% to less than or equal to about 10% by weight.

The monofunctional polyethers can have virtually any desired arrangement of oxyalkylene units with the proviso that these contain less than 20% of copolymerized oxyethylene, based on the total weight of the monofunctional polyether. This weight percentage includes the initiator or starter and all of the added epoxide(s). In general, all of the oxyethylene units are not concentrated at the end of the polyoxyalkylene monols such that the primary hydroxyl group content of the monol is less than 23% by weight. Some examples of suitable monofunctional polyethers include PO homopolymers, block EO-PO copolymers, random EO/PO copolymers, PO polymers that are “tipped” with EO or with a mixture of EO and PO are possible but not preferred. These “tipped” PO polymers should use a mixture of EO and PO to achieve a particular oxyethylene content and/or a desired primary hydroxyl content (less than 23%), or any other desired configuration. The so-called PO homopolymers are suitable with the proviso that they satisfy the above described amounts of copolymerized oxyethylene.

Suitable polyether polyols for component (a)(ii) typically have a hydroxyl number of from about 47 to about 300, and a nominal functionality of 2. These polyether polyols may have hydroxyl numbers of from at least about 47, or from at least about 70. The polyether polyols may also have hydroxyl numbers of less than or equal to 300, or of less than or equal to 240. Suitable polyether polyols may also have a hydroxyl number ranging between any combination of these upper and lower values, inclusive, of from at least about 47 to about 300, or from at least about 70 to about 240. These polyether polyols (ii) may be prepared from low molecular weight starters such as, for example, propylene glycol, dipropylene glycol, ethylene glycol, tripropylene glycol, water, methyl-1,3-propanediol, and the like, and mixtures thereof.

Suitable polyether polyols for component (a)(ii) contain from about 5 to about 45% by weight of copolymerized oxyethylene. These polyether polyols may contain at least about 5%, or at least about 10%, or at least about 15%, of copolymerized oxyethylene, based on the total weight of the polyether polyol (a)(ii). These polyether polyols may contain about 45% or less, or about 40% or less, or about 35% or less of copolymerized oxyethylene, based on the total weight of the polyether polyol (a)(ii). The total weight of the polyether polyol includes the starter or initiator, and the all of the added epoxide(s). Suitable polyether polyols herein may contain any amount of copolymerized oxyethylene between the above disclosed upper and lower values, inclusive, unless otherwise stated, such as at least about 5% to about 45% by weight or less, or at least about 10% to about 40% by weight or less, or at least about 15% to about 35% by weight or less.

These polyether polyols (a)(ii) can be block EO-PO copolymers, EO-capped polyoxypropylenes, random EO/PO copolymers, PO polymers that are “tipped” with a mixture of EO and PO to achieve the desired amount of copolymerized oxyethylene and/or a particular primary hydroxyl content, or any other desired configuration.

Suitable polyether polyols for component (a)(iii) typically have a hydroxyl number of from about 47 to about 300, a nominal functionality of greater than 2 to about 8. These polyether polyols may also have hydroxyl numbers of from at least about 47, or from at least about 70. The polyether polyols may also have hydroxyl numbers of less than or equal to 300, or of less than or equal to 240. Suitable polyether polyols may also have a hydroxyl number ranging between any combination of these upper and lower values, inclusive, of from at least about 47 to about 300, or from at least about 70 to about 240. The polyether polyols may also have a nominal functionality of greater than 2, or of at least about 3. The nominal functionality of the polyether polyols may also be less than or equal to about 8, or less than or equal to about 6. Suitable polyether polyols may have a nominal functionality ranging between any combination of these upper and lower values, inclusive, such as from greater than 2 to about 8, or from at least about 3 to about 6. These polyether polyols (iii) may be prepared from low molecular weight starters such as, for example, glycerin, trimethylolpropane, pentaerythritol, sucrose, sorbitol, and the like, and mixtures thereof.

Suitable polyether polyols for component (a)(iii) contain from about 5 to about 45% by weight of copolymerized oxyethylene. These polyether polyols may contain at least about 5%, or at least about 10%, or at least about 15%, of copolymerized oxyethylene, based on the total weight of the polyether polyol (a)(iii). These polyether polyols may contain about 45% or less, or about 40% or less, or about 35% or less of copolymerized oxyethylene, based on the total weight of the polyether polyol (a)(iii). The total weight of the polyether polyol includes the starter or initiator, and the all of the added epoxide(s). Suitable polyether polyols herein may contain any amount of copolymerized oxyethylene between the above disclosed upper and lower values, inclusive, unless otherwise stated, such as at least about 5% to about 45% by weight or less, or at least about 10% to about 40% by weight or less, or at least about 15% to about 35% by weight or less.

These polyether polyols (a)(iii) can be block EO-PO copolymers, EO-capped polyoxypropylenes, random EO/PO copolymers, PO polymers that are “tipped” with a mixture of EO and PO to achieve the desired amount of copolymerized oxyethylene and/or a particular primary hydroxyl content, or any other desired configuration.

Polyol blend (a) comprises from about 20% to about 50% (preferably 25 to 45%) by weight of (i) the monofunctional polyethers and the balance of the polyol blend comprises components (ii) and (iii), in which from about 10 to about 90% (preferably 15 to 85%) by weight of the balance comprises component (ii) and from about 90% to about 10% (preferably 85 to 15%) by weight of the balance comprises component (iii).

The isocyanate-reactive component may additionally comprise (b) one or more polyether polyols. Suitable polyether polyols (b) include those polyols which have an average functionality of from 2 to 8, a hydroxyl number of at least about 20 to about 300 or less, and contain at least 50% of copolymerized oxyethylene, based on the total by weight of the polyether polyol (b). As previously stated, these polyether polyols are different than the polyether polyols (a)(ii) and (a)(iii). Suitable polyether polyols for component (b) may commonly be referred to as cell opening polyols.

These polyether polyols for component (b) may have hydroxyl numbers of at least about 20 mg KOH/g, or at least about 30 mg KOH/g, or at least about 35 mg KOH/g. In addition, the polyether polyols generally have hydroxyl numbers of about 300 mg KOH/g or less, or about 170 mg KOH/g or less, or about 50 mg KOH/g or less. The suitable polyether polyols of the present invention may be characterized by a hydroxyl number between any combination of these upper and lower values, inclusive, unless otherwise stated, such as, at least about 20 to about 300 mg KOH/g or less, or at least about 30 to about 170 mg KOH/g or less, or at least about 35 mg KOH/g to about 50 mg KOH/g or less.

The average functionality of these polyether polyols (b) ranges is at least 2, or at least about 2.5. The average functionality is also typically about 8 or less, or about 6 or less. The average functionality of the polyether polyols (b) may range between any combination of these upper and lower values, inclusive, such as at least about 2 to about 8 or less, or at least about 2.5 to about 6 or less.

Suitable polyether polyols used as component (b) may also contain at least 50% to about 99% by weight or less of copolymerized oxyethylene, based on the total weight of the polyether polyol. The total weight of the polyether polyol includes the starter or initiator, and the all of the added epoxide(s). These polyether polyols may contain at least about 50%, or at least about 60% or at least about 70% by weight, of copolymerized oxyethylene, based on the total weight of the polyether polyol. These polyether polyols may also contain about 99% or less, or about 90% or less, or about 85% or less of copolymerized oxyethylene, based on the total weight of the polyether polyol. Suitable polyether polyols herein may contain any amount of copolymerized oxyethylene between the above disclosed values, inclusive, such as at least about 50% to about 99% or less, or at least about 60% to about 90% or less, or at least about 70% to about 85% by weight or less, of copolymerized oxyethylene.

Some examples of suitable polyether polyols for component (b) include those compounds which are conveniently made by reacting compounds having two or more active hydrogens (e.g., glycols, triols, tetrols, hexols, polyfunctional amines and other polyfunctional starters known to those in the art) with one or more equivalents of an epoxide as described earlier. Examples of suitable starters for these polyether polyols (b) include low molecular weight starters such as, for example, glycerin, propylene glycol, dipropylene glycol, ethylene glycol, trimethylolpropane, sucrose, sorbitol, tripropylene glycol, water, methyl-1,3-propanediol, pentaerythritol, and the like, and mixtures thereof.

Suitable epoxides for component (b) can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes and many more.

These polyether polyols can have any desired arrangement of oxyalkylene units with the proviso that they contain at least 50% of copolymerized oxyethylene, based on the total weight of the polyether polyol. Thus, the polyether polyols (b) can be EO homopolymers, block EO-PO copolymers, EO-capped polyoxypropylenes, PO capped polyoxyethylenes, random EO/PO copolymers, PO polymers that are “tipped” with a mixture of EO and PO to achieve the desired amount of copolymerized oxyethylene and/or a particular primary hydroxyl content, or any other desired configuration.

The isocyanate-reactive component herein may additionally comprise components (c) and/or (d). Components (c) and/or (d) may be present in amounts of from 0 to about 50% by weight, or from about 1 to about 40% by weight, based on 100% by weight of components (a), (b), (c) and (d).

In one embodiment, these isocyanate-reactive components additionally comprise (c) one or more polyether polyols having an OH number of from about 10 to about 300, an average functionality of from about 2 to about 8, and containing from 0 to 45% by weight of copolymerized oxyethylene, based on the total weight of component (c).

Suitable compounds to be used as polyether polyols (c) include those polyols which have an average functionality of at least about 2 to about 8 or less, a hydroxyl number of at least about 10 to about 300 or less, and contain from 0% to about 45% by weight of copolymerized oxyethylene, based on the total weight of the polyether polyol (c). These polyether polyols are different than the polyether polyols (a)(ii) and the polyether polyols (a)(iii).

These polyether polyols for component (c) may have hydroxyl numbers of from at least about 10 mg KOH/g, or at least about 20 mg KOH/g, or at least about 25 mg KOH/g. In addition, the polyether polyols generally have hydroxyl numbers of about 300 mg KOH/g or less, or about 150 mg KOH/g or less, or about 75 mg KOH/g or less. The suitable polyether polyols of the present invention may be characterized by a hydroxyl number between any combination of these upper and lower values, inclusive, unless otherwise stated, such as, from at least about 10 to about 300 mg KOH/g or less, or at least about 20 to about 150 mg KOH/g or less, or at least about 25 mg KOH/g to about 75 mg KOH/g or less.

The average functionality of these polyether polyols (c) ranges from at least about 2 to about 8 or less. These polyether polyols may also have an average functionality of at least about 2, or at least about 2.5, or at least about 3. These polyether polyols may have an average functionality of 8 or less, or of 6 or less, or of 4 or less. In addition, these polyether polyols may have an average functionality between any combination of these upper and lower values, inclusive, such as at least about 2 to about 8 or less, or at least about 2.5 to about 6 or less, or at least about 3 to about 4 or less.

Some examples of suitable polyether polyols for component (c) include those compounds which are conveniently made by reacting compounds having two or more active hydrogens (e.g. glycols, triols, tetrols, hexols, polyfunctional amines and other polyfunctional starters known to those in the art) with one or more equivalents of an epoxide as described earlier. Examples of suitable starters for these polyether polyols (c) include low molecular weight starters such as, for example, glycerin, propylene glycol, dipropylene glycol, ethylene glycol, trimethylolpropane, sucrose, sorbitol, tripropylene glycol, water, methyl-1,3-propanediol, pentaerythritol, and the like, and mixtures thereof.

Suitable epoxides for component (c) can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes and many more.

In one embodiment, the isocyanate-reactive component may additionally comprise (d) one or more filled polyols which are also known as polymer polyols. Examples of suitable filled polyols for the invention include, for example, (i) styrene/acrylonitrile polymer polyols, (ii) polyisocyanate polyaddition (PIPA) polyols which are dispersions of polyurethanes formed by the in-situ reaction of an isocyanate and an alkanolamine, (iii) polyhydrazodicarbonamide dispersion polyols (also known as PHD polyols), and (iv) mixtures thereof.

Suitable (i) SAN polymer polyols herein are prepared by free radical polymerization of monomers (i.e. styrene and acrylonitrile) in a polyol carrier (or base polyol) to produce a free radical polymer dispersed in the polyol carrier (or base polyol). Conventionally, the solids content of SAN polymer polyols is from about 5% up to about 60% by weight of solids, based on the total weight of the SAN polymer polyol composition. The solids content may be at least about 5%, or at least about 10% by weight of solids, based on the total weight of the SAN polymer polyol composition. The solids content may also be about 60% by weight or less, or about 50% by weight or less, based on the total weight of the SAN polymer polyol composition. The amount of solids content may range between any combination of these upper and lower values, inclusive, such as from about 5% to about 60%, or from about 10% to about 50% by weight of solids, based on the total weight of the SAN polymer polyol composition. Generally, these SAN polymer polyols have a viscosity in the range of from about 2,000 to about 8,000 centipoise.

Examples of suitable SAN polymer polyols to be used as component (d) herein include those SAN polymer polyols disclosed in, for example, but are not limited to, U.S. Pat. Nos. 5,324,774, 5,364,906, 5,358,984, 5,453,469, 5,488,085, 5,496, 894, 5,554,662, 5,814,699, 5,824,712, 5,916,994, 5,995,534, 5,990,185, 6,117,937, 6,455,603, 6,472,447, 6,624,209, 6,713,599, 6,756,414, 7,179,882, 7,759,423, etc., the disclosures of which are hereby incorporated by reference.

The SAN polymer polyols suitable for the present invention are prepared by the in-situ polymerization of acrylonitrile and styrene, in a base polyol. Suitable base polyols may be conventional polyether polyols, polyester polyols, poly(oxyalkylene) polyols, etc. Methods for preparing SAN polymer polyols are known and described in, for example, U.S. Pat. Nos. 3,304,273; 3,383,351; 3,523,093; 3,652,639; 3,823,201; 4,104,236; 4,111,865; 4,119,586; 4,125,505; 4,148,840; 4,172,825; 4,524,157; 4,690,956; Re-28,715; and Re-29,118, the disclosures of which are hereby incorporated by reference.

One suitable SAN polymer polyol to be used as component (d) in the present invention comprises the free radical polymerization product of styrene and acrylonitrile in a base polyol, wherein the base polyol has an average functionality of about 3, a molecular weight of about 4750, and an OH number of about 20. The solids content of this SAN polymer polyol is about 43% solids, in which the styrene to acrylonitrile content is about 64% to 36%.

Another suitable SAN polymer polyol for component (d) in the present invention comprises the free radical polymerization product of styrene and acrylonitrile in a base polyol, wherein the base polyol has an average functionality of about 3, a molecular weight of about 3000, and an OH number of about 25. The solids content of this SAN polymer polyol is about 49% solids, in which the styrene to acrylonitrile content is about 67% to 33%.

Suitable polyisocyanate polyaddition (PIPA) polyols for component (d) contain polyurethane particles dispersed in a polyol carrier (i.e. base polyol). The polyurethane particles in PIPA polyols are formed in-situ by the reaction of an isocyanate with an alkanolamine (e.g., triethanolamine). The solids content of the PIPA polyols may typically range from 5% up to about 60% by weight, based on the total weight of the PIPA composition. The solids content may be at least about 5%, or at least about 10% by weight of solids, based on the total weight of the PIPA composition. The solids content may also be about 60% by weight of less, or about 50% by weight or less, based on the total weight of the PIPA composition. The amount of solids content may range between any combination of these upper and lower values, inclusive, such as from about 5% to about 60%, or from about 10% to about 50% by weight of solids, based on the total weight of the PIPA composition.

Generally, PIPA polyols have a viscosity in the range of from about 4,000 to about 50,000 centipoise. Examples of suitable PIPA polyols can be found in, for example, U.S. Pat. Nos. 4,374,209 and 5,292,778, the disclosures of which are herein incorporated by reference.

Suitable polyhydrazodicabonamide polyols (which are also commonly referred to as PHD polyols or PHD dispersion polyols) to be used as component (d) of the present invention include, for example, those compounds which are typically prepared by the in-situ polymerization of an isocyanate mixture with an amine group containing compound such as, a diamine and/or a hydrazine, in a base polyol. Suitable base polyols typically comprise polyether polyols and polyoxyalkylene polyols. Methods for preparing PHD polymer polyols are described in, for example, U.S. Pat. Nos. 4,089,835 and 4,260,530, the disclosures of which are hereby incorporated by reference.

PHD polyols typically have solids contents within the range of from about 3 to about 30 weight %, based on the total weight of the PHD polyol. The solids content of the PHD polyols may be from at least about 3%, or from at least about 5% by weight, based on the total weight of the PHD polyol. The solids content of the PHD polyols may also be about 30% or less, or about 25% by weight or less, based on the total weight of the PHD polyol. The PHD polyols may have a solids content that ranges between any combination of these upper and lower values, inclusive, such as from about 3% to about 30% by weight, or from about 5 to about 25% by wt., based on the total weight of the PHD polyol.

As previously stated, PHD polyols are typically prepared by the in-situ polymerization of an isocyanate mixture in a polyol. More specifically, the isocyanate mixture typically comprises about 80 parts by weight, based on the total weight of the isocyanate mixture, of 2,4-toluene diisocyanate, and about 20 parts by weight, based on the total weight of the isocyanate mixture, of 2,6-toluene diisocyanate.

Suitable amine group containing compounds to be polymerized with the isocyanate compound include in preparing the PHD polyols, for example, compounds such as polyamines, hydrazines, hydrazides, ammonia or mixtures of ammonia and/or urea and formaldehyde.

Suitable polyamines include divalent and/or higher valent primary and/or secondary aliphatic, araliphatic, cycloaliphatic and aromatic amines, e.g. ethylene diamine; 1,2- and 1,3-propylene diamine; tetramethylene diamine; hexamethylene diamine; dodecamethylene diamine; trimethyl diaminohexane; N,N′-dimethyl-ethylenediamine; 2,2′-bisaminopropyl-methylamine; higher homologues of ethylene diamine, such as diethylene triamine, triethylene tetramine and tetraethylene pentamine; homologues of propylene diamine, such as dipropylene triamine, piperazine, N,N′-bis-aminoethyl-piperazine, triazine, 4-aminobenzylamine, 4-aminophenyl ethylamine, 1-amino-3,3,5-trimethyl-5-aminomethylcyclohexane, 4,4′-diaminodicyclohexyl-methane and -propane, 1,4-diaminocyclohexane, phenylenediamines, naphthylene diamines; condensates of aniline and formaldehyde; tolylene diamines; the bis-aminomethylbenzenes and derivatives of the above mentioned aromatic amines monoalkylated on one or both nitrogen atoms. The polyamines generally have a molecular weight of from 48 to They may also have molecular weights of 60 to 1000, or of 62 to 200.

The hydrazines used may be hydrazine itself or monosubstituted or N,N′-disubstituted hydrazines. The substituents may be C1 to C6 alkyl groups, cyclohexyl groups or phenyl groups. The hydrazines generally have a molecular weight of from 32 to 200. Hydrazine itself is suitable for the invention herein.

Suitable hydrazides include the hydrazides of divalent or higher valent carboxylic acids such as carbonic acid, oxalic acid, malonic acid, succinic acid, adipic acid, sebacic acid, azelaic acid, maleic acid, fumaric acid, phthalic acid, isophthalic acid, and terephthalic acid; the esters of a hydrazine monocarboxylic acid with dihydric or higher hydric alcohols and phenols such as ethanediol, propane-1,2-diol, butane-1,2-diol, −1,3-diol and -1,4-diol, hexanediol, diethyleneglycol, triethyleneglycol, tetraethyleneglycol, dipropyleneglycol, tripropyleneglycol and hydroquinone; and the amides of hydrazinomonocar-boxylic acid (semicarbazides), e.g. with the above mentioned diamines and polyamines. The hydrazides generally have a molecular weight of from 70 to 10,000, or from 75 to 1000, or from 90 to 500. Any combination of these upper and lower limits for molecular weights can be used for the hydrazides herein.

In special cases, a proportion of isocyanates or amines, hydrazines and hydrazides which have an average functionality higher than 2 may also be used, especially in combination with the corresponding monofunctional compounds.

Preferred base polyols for preparing the PHD polyols comprise polyether polyols and poly(oxyalkylene) polyols.

PHD polymer modified polyols are typically prepared by the in-situ polymerization of an isocyanate mixture with a diamine and/or hydrazine in a base polyol, preferably, a polyether polyol. Methods for preparing PHD polymer polyols are described in, for example, U.S. Pat. Nos. 4,089,835, 4,260,530 and 4,324,715, the disclosures of which are hereby incorporated by reference.

In one embodiment, the polyol blend (a) may be continuously added and mixed in-line prior to the foam mixhead.

In another embodiment, the polyol blend (a) may comprise an in-situ formed polyol blend.

The polyol blend (a) may be also comprise a mixture that is prepared by combining components (a)(i), (a)(ii) and (a)(iii).

The in-situ formed polyol blends suitable for use as (a) may be formed by
A) introducing into a reaction vessel a mixture comprising:
   (1) an initial starter (Si) comprising one or more monofunctional compounds having a hydroxyl number of less than about 56, and
   (2) a DMC (double metal cyanide) catalyst,
B) feeding an epoxide comprising propylene oxide and ethylene oxide in a weight ratio of from 100:0 to 20:80, into the reaction vessel;
C) allowing the epoxide mixture and the initial starter (Si) to react and continue polymerizing by feeding the epoxide until the equivalent weight of the monofunctional compound is increased by at least 10% by weight and reaches a value between about 1,500 and about 6,000;
D) continuously adding one or more low molecular weight starters (Sc) having a functionality of greater than 2 to about 6, and an equivalent weight of about 28 to about 400 into the reaction vessel while continuing to feed epoxide;
E) completing addition of the continuous starter (Sc); and
F) allowing the mixture to continue to polymerize in the reaction vessel thereby forming (a) an in-situ formed polyol blend having an overall hydroxyl number of from about 56 to about 250, an average functionality of greater than 2, and which comprises
   (i) one or more monofunctional polyethers having a hydroxyl number of less than or equal to 56, and containing less than 20% by weight of copolymerized oxyethylene, based on 100% by weight of the monofunctional polyethers (a)(i);
   (ii) one or more polyether polyols having a hydroxyl number of 47 to 300, a nominal functionality of 2 and containing from about 5 to about 45% by weight of copolymerized oxyethylene, based on 100% by weight of the polyether polyols (a)(ii); and
   (iii) one or more polyether polyols having a hydroxyl number of about 47 to about 300, a nominal functionality of greater than 2 to about 8, and containing from about 5 to about 45% by weight of copolymerized oxyethylene, based on 100% by weight of the polyether polyols (a)(iii);
   wherein (a) said polyol blend comprises from 20 to 50% by weight of (i) said monofunctional polyether monols and the balance of (a) comprises components (ii) and (iii) in which from 10 to 90% by weight of the balance comprises component (ii) and from 90 to 10% by weight of the balance comprises component (iii);
and, optionally,
(II) combining the resultant in-situ produced polyol blend (a) with
   (b) up to 80% by weight, based on 100% by weight of components (a) and (b), of at least one polyether polyol having an average functionality of 2 to 8, a hydroxyl number of 20 to 300 and containing at least 50% of copolymerized oxyethylene, based on 100% by weight of the polyether polyol (b).

In general, any epoxide polymerizable using DMC catalysis can be used in the in-situ production of the polyol blend comprising a monofunctional polyether and two different polyether polyols. Suitable epoxides include ethylene oxide, propylene oxide, butylene oxides (e.g., 1,2-butylene oxide, isobutylene oxide), styrene oxide, and the like, and mixtures thereof. Polymerization of epoxides using DMC catalysts and hydroxyl-containing starters results in polyether polyols, as is well understood in the art.

Other monomers that will copolymerize with an epoxide in the presence of a DMC catalyst may be included in the process of the invention to make other types of epoxide polymers. Some examples include epoxides copolymerize with oxetanes as described in U.S. Pat. No. 3,404,109, the disclosure of which is herein incorporated by reference, to give polyethers, or with anhydrides to give polyesters or polyetheresters as described in U.S. Pat. Nos. 5,145,883 and 3,538,043, the disclosures of which are herein incorporated by reference, or with carbon dioxide to form polyethercarbonate polyols such as those described in U.S. Pat. Nos. 4,826,887, 4,826,952, 4,826,953, 6,713,599, 7,977,501, 8,134,022, 8,324,419, 8,946,466 and 9,249,259, the disclosures of which are herein incorporated by reference, and U.S. Published Patent Application 2015/0232606.

In accordance with this process, an initially charged starter (Si) is used, and the initially charged starter (Si) is different than the continuously added starter (Sc). The initially charged starter, Si, is comprised of, either totally or in large part, one or more compounds having one active hydrogen per molecule that can serve as a site for epoxide addition. The preferred starters are polyether monols formed by addition of multiple equivalents of epoxide to low molecular weight monofunctional starters such as, for example, methanol, ethanol, phenols, allyl alcohol, longer chain alcohols, etc., and mixtures thereof. Suitable epoxides can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes, and many more. Suitable monofunctional starters can also be made, for example, by first producing a diol or triol and then converting all but one of the remaining hydroxyl groups to an ether, ester or other non-reactive group.

One suitable class of polyether monol starters, Si, includes polyoxypropylene monols having a hydroxyl number of less than or equal to about 56. These compounds facilitate DMC catalyzed addition of epoxide and provide suitable build ratios for the production of the in-situ formed polyether polyol blends herein.

In a process disclosed herein, the quantity of an Si used depends on many factors, including, for example, the reactor dimensions, the identity of the Si, the equivalent weights of the Si and of the target product, the equivalent weight of the Sc, and other factors. In general, the amount of Si is within the range of about 2 to about 75 mole % of the total moles of Si and Sc. The total amount of starter (St) equals the sum of the amount of continuously added starter (Sc) plus the amount of initially charged starter (Si). Thus, St=Sc+Si.

Suitable catalysts comprise double metal cyanide (DMC) catalysts. Any DMC catalyst known in the art is suitable for use in the process of the present invention. These well-known catalysts are the reaction products of a water-soluble metal salt (e.g., zinc chloride) and a water-soluble metal cyanide salt (e.g., potassium hexacyanocobaltate). Preparation of suitable DMC catalysts is described in many references, including, for example, U.S. Pat. Nos. 5,158,922, 4,477,589, 3,427,334, 3,941,849, 5,470,813, and 5,482,908, the disclosures of which are incorporated herein by reference. One suitable type of DMC catalysts are zinc hexacyanocobaltates.

The DMC catalyst includes an organic complexing agent. As disclosed in the preceding references, the complexing agent is needed for an active catalyst. Suitable complexing agents are water-soluble heteroatom-containing organic compounds that can complex with the DMC compound, as well as water-soluble aliphatic alcohols. An example of a suitable aliphatic alcohol is tert-butyl alcohol. The DMC catalyst may include, in addition to the organic complexing agent, a polyether, as is described in U.S. Pat. No. 5,482,908, the disclosure of which is herein incorporated by reference.

Suitable DMC catalysts for use in the process are highly active catalysts such as those described in U.S. Pat. Nos. 5,482,908 and 5,470,813, the disclosures of which are herein incorporated by reference. High activity allows the catalysts to be used at very low concentrations, and possibly at concentrations which are low enough to overcome any need to remove the catalyst from the finished blends of in-situ formed polyol blends.

The process may also require a continuously added polyfunctional starter (Sc). Conventional processes for making polyether polyols, including KOH-catalyzed and DMC-catalyzed processes, charges the catalyst and all of the starter to be used to the reactor at the start of the polymerization, and then adds the epoxide continuously. In the process of forming an in-situ formed polyol blend suitable for the invention, the DMC catalyst and an initial monofunctional starter (Si) are charged to the reactor followed by epoxide feed and polymerization until the monol reaches the desired equivalent weight. At this point, the feed of continuously added polyfunctional starter (Sc) is begun and it proceeds at a continuous controlled rate relative to the continuing epoxide feed until the addition of the continuous starter (Sc) is completed. Epoxide feed is continued until the desired overall OH number, is reached. The Sc may be mixed with the epoxide and added, or it may be added as a separate stream.

The Sc is typically a low molecular weight polyol or a blend of low molecular weight polyols. Low molecular weight polyols as defined in this application have from about 2 hydroxyl groups to about 8 hydroxyl groups. It also may be beneficial to add more than one Sc having different functionalities either simultaneously or sequentially. The functionality of the Sc or multiple Sc should be chosen such at the average functionality of the resultant polyol is greater than 2.0 up to about 6, or from about 2.5 up to about 3. These low molecular weight polyols may have at least about 2 hydroxyl groups, or greater than 2 hydroxyl groups, or at least about 2.5 hydroxyl groups. These low molecular weight polyols may also have about 8 hydroxyl groups or less, or about 6 hydroxyl groups or less, or about 3 hydroxyl groups or less. The low molecular weight polyols used for the Sc may contain any number of hydroxyl groups which ranges between any combination of these upper and lower values, inclusive, such as from at least 2 hydroxyl groups to about 8 hydroxyl groups or less, or greater than about 2 to about 6, or at least about 2.5 to about 3 hydroxyl groups or less.

Suitable low molecular weight polyols for the Sc have a nominal functionality of greater than 2 to about 8 and an equivalent weight of about 28 to about 400.

Examples of suitable low molecular weight polyols include compounds such as, for example, glycerin, propylene glycol, dipropylene glycol, ethylene glycol, trimethylolpropane, sucrose, sorbitol, tripropylene glycol, and the like, and mixtures thereof. In one embodiment, the continuously added starter comprises propylene glycol and glycerin. Low molecular weight polyether polyols prepared by multiple epoxide addition to these polyols or other starters with two or more active hydrogens may also be employed as Sc.

The Sc can also be other compounds having at least two active hydrogens per molecule, which are known to be suitable initiators for conventional DMC-catalyzed epoxide polymerizations, including compounds such as, for example, alcohols, thiols, aldehydes and ketones containing enolizable hydrogens, malonic esters, phenols, carboxylic acids and anhydrides, aromatic amines, acetylenes, and the like, and mixtures thereof. Examples of suitable active hydrogen-containing compounds appear in U.S. Pat. Nos. 3,900,518, 3,941,849, and 4,472,560, the disclosures of which are incorporated herein by reference.

The amount of Sc used is at least about 25 mole percent of the total amount of starter used.

$$mole \% {S}_{c} = ( \frac{moles {S}_{c}}{moles {S}_{c} + moles {S}_{i}} ) \times 100$$

As described previously, a wide variety of epoxides can be employed in the current process. Propylene oxide and ethylene oxide are the most commonly used epoxides. A unique feature of the current process is that the compositions of the epoxide can be varied to control the composition of the polyether monol and polyether polyol constituents in the final product. For example, propylene oxide can be added alone during polymerization of the monol, prior to the start of the addition of the Sc, the continuously added starter. After Sc addition is started, a blend of ethylene oxide and propylene oxide can be fed to yield a high functionality polyether polyol comprised of a poly(oxyethylene-oxypropylene) copolymer. Because oxide addition via DMC catalysis occurs predominantly on the lower equivalent weight polyether polyol, the polyether monol component can remain largely poly(oxypropylene). By reversing these sequences, the polyether monol could be produced with higher poly(oxyethylene) content and the polyether polyol could be predominantly poly(oxypropylene).

The epoxide composition may also be varied during the initial polymerization of the monol and/or at some point during and/or after the addition of Sc. This provides flexibility for controlling the distribution of oxyethylene or oxypropylene within the monofunctional polyether and polyether polyols and allows some control of the primary versus secondary hydroxyl functionality of the monofunctional polyether and polyether polyols, and thus, the relative reactivity of the constituents in the final composition. In this way, it is possible to design the product to meet the reactivity and performance requirements of the intended applications such as viscoelastic polyurethane foams.

The in-situ formed polyol blend (a) essentially corresponds to the polyol blend (a) described herein above, and is characterized by the same overall hydroxyl numbers and average functionalities.

As previously described, the in-situ formed polyol blends (a) comprise (i) one or more monofunctional polyols having a hydroxyl number of less than or equal to 56 and containing less than or equal to 20% by weight of copolymerized oxyethylene, (ii) one or more polyether polyols having a hydroxyl number of from 47 to 300, a nominal functionality of 2, and containing from about 5 to about 45% by weight of copolymerized oxyethylene, and (iii) one or more polyether polyols having a hydroxyl number of about 47 to about 300, a nominal functionality of greater than 2 to about 6, and containing from about 5 to about 45% by weight of copolymerized oxyethylene. These individual components (i), (ii) and (iii) of the in-situ formed polyol blend correspond essentially to the individual components (i), (ii) and (iii) of the polyol blend (a) described previously with respect to hydroxyl number, nominal functionality and content of copolymerized oxyethylene.

Suitable polyether polyols to be used as component (II)(b) which may optionally be combined with the in-situ prepared polyol blend may have an average functionality of 2 to 8, a hydroxyl number of 20 to 300 and comprise at least 50% of copolymerized oxyethylene, based on 100% by weight of the polyether polyol (II)(b).

These polyether polyols (b) suitable for the in-situ formed blend correspond essentially to those polyether polyols (b) which are suitable for adding to the polyol blend (a) above and are previously described with respect to the hydroxyl number, average functionality and content of copolymerized oxyethylene.

In one embodiment, the in-situ formed polyol blends (a) may additionally comprise (II)(c) one or more polyether polyols having an OH number of from about 10 to about 300 and an average functionality of about 2 to about 8, and/or (d) one or more filled polyols. The one or more polyether polyols (c) and one or more filled polyols (d) suitable herein correspond essentially to those polyether polyols (c) and filled polyols (d) described previously with respect to the polyol blends (a) in terms of hydroxyl number, functionality, etc.

The process for the production of a viscoelastic polyurethane foam comprises reacting (1) an isocyanate-functional component comprising toluene diisocyanate, with (2) an isocyanate-reactive component in the presence of components comprising a blowing agent, a catalyst, and a surfactant, wherein the isocyanate-functional component and the isocyanate-reactive component are reacted at an isocyanate index of 90 to 120. Suitable isocyanate-reactive components (2) comprise: (a) from 20 to 100% by weight, based on 100% by weight of components (a) and (b), of a polyol blend having a hydroxyl number of from about 56 to about 250, an average functionality greater than about 2 and comprising: (i) one or more monofunctional polyethers having a hydroxyl number of less than or equal to 56, and containing less than 20% by weight of copolymerized oxyethylene, based on the total weight of (a)(i); (ii) one or more polyether polyols having a hydroxyl number of about 47 to about 300, a nominal functionality of 2, and containing from about 5 to about 45% by weight of copolymerized oxyethylene, based on the total weight of (a)(ii); and (iii) one or more polyether polyols having a hydroxyl number of from 47 to 300, a nominal functionality of greater than 2 to 8, and containing from 5 to 45% of copolymerized oxyethylene, based on the total weight of the polyether polyol (iii); wherein (a) the polyol blend comprises 20 to 50% by weight of (i) one or more monofunctional polyethers and the balance of (a) comprises components (ii) and (iii) in which from 10 to 90% by weight of the balance comprises component (ii) and from 90 to 10% by weight of the balance comprises component (iii); and, optionally (b) up to 80% by weight, based on 100% by weight of component (a) and component (b), of one or more polyether polyols having an average functionality of 2 to 8, a hydroxyl number of 20 to 300 and comprising at least 50% of copolymerized oxyethylene, based on 100% by weight of component (b).

In accordance with the present invention, the quantity, OH number and functionality of components (2)(a)(i), (2)(a)(ii) and (2)(a)(iii) are selected such that the resultant viscoelastic polyurethane foam has a storage modulus ratio at 15° C. to 30° C. of less than or equal to 5, and the resultant viscoelastic foam has a Tg of less than 20° C. as measured by tan delta, over a density range of from about 1.0 to about 6.0 pcf, and at an isocyanate index of greater than 95 to about 110.

The viscoelastic polyurethane foam will typically have a storage modulus ratio at to 30° C. of less than or equal to 5, or less than or equal to 4, or less than or equal to 3. The storage modulus ratio at 15° C. to 30° C. will also typically be greater than or equal to 1, or greater than or equal to 1.1, or greater than or equal to 1.2. Thus, the resultant viscoelastic foams will typically have a storage modulus ratio at 15° C. to 30° C. ranging between any combination of these upper and lower values, inclusive, such as of less than or equal to 5 to greater than or equal to 1, or less than or equal to 4 to greater than or equal to 1.1, or less than or equal to 3 to greater than or equal to 1.2.

In addition, the resultant viscoelastic polyurethane foam also has a Tg of less than or of less than 18° C., or of less than 17° C., or of less than 16° C., or of less than 15° C., as measured by tan delta.

The viscoelastic polyurethane foams herein have a density in the range of from about 1.0 pcf to about 6.0 pcf, preferably 2.0 to 5.0 pcf.

The isocyanate index used to prepare the viscoelastic polyurethane foams herein ranges from greater than 95 to about 110. The isocyanate index may be greater than 95, or greater than or equal to 96, or greater than or equal to 97. The isocyanate index may also be less than or equal to 110, or less than or equal to 109, or less than or equal to 107. The isocyanate index may range between any combination of upper and lower ranges, inclusive, such as from greater than 95 to less than or equal to 110, or from 96 to 109, or from 97 to 107.

In addition, in the process of preparing the viscoelastic polyurethane foam, the isocyanate-reactive component may additionally comprise at least one of: (c) one or more polyether polyols having an OH number of from about 10 to about 300, an average functionality of from about 2 to about 8, and containing from 0 to 45% by weight of copolymerized oxyethylene, based on 100% by weight of component (c); and/or (d) one or more filled polyols. Suitable polyether polyols (c) and filled polyols (d) for the process essentially correspond to those described previously with respect to the isocyanate-reactive compositions.

Suitable isocyanate-functional compounds comprise toluene diisocyanate (TDI, which is usually a mixture of 2,4- and 2,6-isomers), and various mixtures thereof.

In one embodiment, a foam modifier or foam processing aid is added to the formulation to enhance processing and help stabilize the viscoelastic foam against cold flow and/or dishing by providing dimensional stability against deformation and reduced settling of the viscoelastic foam. These processing aids or modifiers are typically chain extenders and/or cross-linking agents. In general, chain extenders and/or cross-linking agents are relatively small molecules which contain from 2 to 8 active hydrogen groups. The chain extenders and/or cross-linking agents may contain at least 2 active hydrogen groups, or at least 3 active hydrogen groups. Chain extenders and/or cross-linking agents may also contain less than or equal to 8 active hydrogen groups, or less than or equal to 6 active hydrogen groups. Suitable chain extenders and/or cross-linking agents may contain any number of active hydrogen groups in any combination ranging between these upper and lower values, inclusive, such as at least 2 to less than or equal to 8 active hydrogen groups, or at least 3 to less than or equal to 6 active hydrogen groups. Suitable chain extenders and/or cross-linking agents are added in amounts of from 0 to 4 parts per hundred parts of polyol. Some examples of suitable chain extenders and/or cross-linking agents that may be included in the reaction mixture of the invention include diethanolamine (DEOA), ethylene glycol (EG), diethylene glycol (DEG), propylene glycol (PG), dipropylene glycol (DPG), 1,4-butanediol (BDO), Arcol DP1022, Ortegol 204, Geolite 206 and Geolite 210. Some of these aids are described in, for example, U.S. Pat. Nos. 4,950,694 and 5,539,011, the disclosures of which are hereby incorporated by reference. Processing additives are particularly useful in accordance with the invention when TDI is used as the isocyanate component. These chain extenders and/or cross-linking agents may be present in amount of 0 parts or higher, or of 0.3 parts or higher, per hundred parts of polyol. The chain extenders and/or crosslinking agents may also be present in amounts of 4 parts or less, or of 2 parts or less, per hundred parts of polyol. The amount of chain extenders and/or crosslinking agent present may range between any combination of these upper and lower values, inclusive, such as from 0 to 4 parts, or from 0.3 to 2 parts per hundred parts polyol. It may also be beneficial at times to use a combination of these different foam modifiers or processing aids.

In addition, the foam modifiers or processing aids may have an OH number of at least 300, or of at least 600.

Suitable blowing agents include, for example chemical blowing agents, i.e. isocyanate reactive agents that generate blowing gases, such as for example water and formic acid and physical blowing agents such as acetone, carbon dioxide, chlorofluorocarbons, highly fluorinated and/or perfluorinated hydrocarbons, chlorinated hydrocarbons, aliphatic and/or cycloaliphatic hydrocarbons such as propane, butane, pentane, hexane, etc., or acetals such as methylal. These physical blowing agents are usually added to the polyol component of the system. However, they can also be added in the isocyanate component or as a combination of both the polyol component and the isocyanate component. It is also possible to use them together with highly fluorinated and/or perfluorinated hydrocarbons, in the form of an emulsion of the polyol component. If emulsifiers are used, they are usually oligomeric acrylates which contain polyoxyalkylene and fluoroalkane radicals bonded as side groups and have a fluorine content of from about 5 to 30% by weight. Such products are sufficiently well known from plastics chemistry, and are described in U.S. Pat. No. 4,972,002, the disclosure of which is herein incorporated by reference.

The amount of blowing agent or blowing agent mixture used may range from 0.5 to 20% by weight, based on 100% by weight of the isocyanate-reactive component. In some instances, the amount of blowing agent present may be at least 0.5% or at least 0.75% by weight, based on 100% by weight of the isocyanate-reactive component. The amount of blowing agent present may also be about 20% or less, or about 10% by weight or less, based on 100% by weight of the isocyanate-reactive component. The blowing agent may be present in any amount ranging between any combination of these upper and lower above values, inclusive, such as from at least about 0.5% to about 20% or less, or from at least about 0.75% to about 10% by weight or less, based on 100% by weight of isocyanate-reactive component.

When water is the blowing agent, the amount of water typically present can range from at least about 0.5 to about 10%, based on 100% by weight of the isocyanate-reactive component. In some instances, the amount of blowing agent present may be at least 0.5% or at least 0.75% by weight, based on 100% by weight of the isocyanate-reactive component. The amount of water present as a blowing agent may also be about 10% or less, or about 7% by weight or less, based on 100% by weight of the isocyanate-reactive component. The blowing agent may be present in any amount ranging between any combination of these upper and lower values, inclusive, such as from at least about 0.5% to about 10% or less, or from at least about to about 7% by weight or less, based on 100% by weight of isocyanate-reactive component. The addition of water can be effected in combination with the use of the other blowing agents described. In accordance with the present invention, water is the preferred blowing agent. Also, preferred is the use of water along with pressurized carbon dioxide that is dispersed in the polyol or resin blend and frothed by passing through a pressure let down device such as employed for example in the Henecke Novaflex, CarDio (Cannon Viking Limited) and Beamech (CO-2) machines, which are known by those skilled in the art.

The viscoelastic foam is produced in the presence of a surfactant, which helps to stabilize the viscoelastic foam until it cures. Suitable surfactants are those well known in the polyurethane industry. A wide variety of organosilicone surfactants are commercially available. Examples of suitable surfactants are Niax L-620 surfactant, a product of Momentive Performance Materials, and Tegostab B8244, a product of Evonik-Goldschmidt. Many other silicone surfactants known to those in the art may be substituted for these suitable silicones. The surfactant is typically used in an amount within the range of from at least about 0.1 to about 4 parts, per 100 parts of isocyanate-reactive mixture. Surfactants may be present in amounts ranging from at least about 0.1, or from at least about 0.2 parts per 100 parts of isocyanate-reactive mixture.

The surfactants may be also present in amounts ranging from about 4 parts or less, or from about 3 parts or less, per 100 parts of isocyanate-reactive mixture. The amount of surfactants may range between any combination of these upper and lower values, inclusive, such as from at least about 0.1 to about 4 parts, or from at least about 0.2 to about 3 parts, per 100 parts of isocyanate-reactive mixture.

At least one polyurethane catalyst is required to catalyze the reactions of the isocyanate-reactive components and water with the polyisocyanate. It is common to use both an organoamine and an organotin compound for this purpose. Suitable polyurethane catalysts are well known in the art; an extensive list appears in U.S. Pat. No. 5,011,908, the disclosure of which is herein incorporated by reference. Suitable organotin catalysts include tin salts and dialkyltin salts of carboxylic acids. Examples include stannous octoate, dibutyltin dilaurate, dibutyltin diacetate, stannous oleate, and the like. Stannous octoate is particularly preferred. Preferred organoamine catalysts are tertiary amines such as trimethylamine, triethylamine, triethylenediamine, bis(2,2′-dimethyl-amino)ethyl ether, N-ethylmorpholine, diethylenetriamine, and the like.

In another embodiment, suitable amine catalysts include non-emissive balanced amines which bind chemically into the polyurethane foam matrix and eliminate contributions to odor and VOC emissions or is of high enough molecular weight so as to not to contribute to VOC emissions. These are also referred to as non-fugitive amine catalysts. Examples of these catalysts include Dabco NE-300 and Dabco NE-500 from Air products,

N,N-bis(3-dimethyl-aminopropyl)-N-isopropanolamine (commercially available as Jeffcat ZR 50), N-(3-dimethylaminopropyl)-N,N-diisopropanolamine (commercially available as Jeffcat DPA), 1,4-diazabicyclo[2.2.2]octane-2-methanol (commercially available as RZETA) from TOSOH Corporation.

The polyurethane catalysts are typically used in an amount within the range of about 0.01 to about 3 parts per 100 parts of isocyanate-reactive mixture. The polyurethane catalysts may be present in amounts of from at least about 0.01, or from at least about 0.1 parts per 100 parts of isocyanate-reactive mixture. The polyurethane catalysts may be present in amounts of about 3 parts or less, or of about 2 parts per 100 parts of isocyanate-reactive mixture. The polyurethane catalysts may be present in any amount ranging between any combination of these upper and lower values, inclusive, such as from at least about 0.01 to about 3 parts, or from at least about 0.1 to about 2 parts, per 100 parts of isocyanate-reactive mixture.

Flame retardants, antioxidants, pigments, dyes, liquid and solid fillers, and many other commercial additives can also be included in the viscoelastic foams in conventional amounts.

The viscoelastic foams are prepared using methods that are well known in the industry. These methods may include continuous or discontinuous free-rise slabstock foam processes and molded foam processes. In a typical slabstock process, the isocyanate is continuously mixed together with the other formulation chemicals by passing through a mixing head and then into a trough which overflows onto a moving conveyor.

Alternatively, the reacting mixture is deposited directly onto the moving conveyor. In another embodiment, high pressure liquid carbon dioxide is fed into one or more of the formulation components, typically the polyol, entering into the mixing head and the resin blend is passed through a frothing device where the pressure is let down and the resultant froth is deposited onto the conveyor. The viscoelastic foam expands and rises as it moves down the conveyor to form a continuous foam slab that is cut into blocks or buns of the desired length for curing and storage. After curing for one or more days, these foam buns can be cut into the desired shapes for the end-use applications. In the discontinuous process, the reactants are quickly mixed together through a head or in a large mixing chamber. The reaction mixture is then deposited into a large box or other suitable container where foam expansion occurs to form a bun of the lateral dimensions of the container.

A typical molded viscoelastic foam process usually employs a one-shot approach in which a specific amount of the isocyanate stream (the “A” side) is rapidly combined and mixed with a specific amount of the remaining formulation components (the “B” side). An additional stream may be employed to bring in one or more specific components not included with the “B” side stream. The mixture is quickly deposited into a mold that is then closed. The viscoelastic foam expands to fill the mold and produce a part with the shape and dimensions of the mold.

Although less preferred, a prepolymer approach to making the viscoelastic foams can also be used. In this approach, a significant portion of the isocyanate-reactive mixture is reacted with the polyisocyanate, and the resulting prepolymer is then reacted with the remaining components.

The test used to define foam recovery rate from deformation is the 95% height recovery time as described in ASTM D 3574-11 Test M. A recovery rate of less than about 3 seconds, indicates a fast recovering foam such as observed for resilient foam types. A recovery rate of greater than or equal to about 3 seconds is indicative of a slow recovery foam often referred to as “viscoelastic” or “memory” foam.

Commercial production of viscoelastic foams involves mixing together a suitable polyisocyanate, a blowing agent, and an isocyanate-reactive component or mixture in the presence of a surfactant, one or more catalysts, and various other compounds which are known in the field of polyurethane chemistry to be suitable for preparing viscoelastic foams. Other isocyanate-reactive compounds to be used in addition to the above described polyol blends which comprise (a) the polyol blend and (b) the polyether polyol having an average functionality of 2 to 8, a hydroxyl number of 20 to 300 and comprising at least 50% by weight of copolymerized oxyethylene, based on the total weight of the polyether polyol, include other conventional polyols which are well known in the field of polyurethane chemistry. These include the relatively high molecular weight compounds such as, for example, polyether polyols, polyester polyols, polymer polyols, amine-terminated polyethers, polythioethers, polyacetals and polycarbonates, as well as various low molecular weight chain extenders and/or crosslinking agents both of which may contain hydroxyl groups and/or amine groups capable of reacting with the isocyanate groups of the isocyanate component.

In addition, the isocyanate-reactive component to be used in the viscoelastic polyurethane foams herein may additionally comprise at least one of (c) one or more polyether polyol having an OH number of from about 10 to about 300, an average functionality of from about 2 to about 8, and which contain from 0 to 45% by weight of copolymerized oxyethylene, based on 100% by weight of component (c); and/or (d) one or more filled polyols which are also commonly referred to as polymer polyols.

As part of the process, a small excess of blowing agent is usually emitted from the bun, also known as blowoff. The timing, locations, amount, and distribution of the blowoff may also give indicators of product quality and raw material utilization.

The reaction of the foam producing mixture to create the polyurethane foams is an exothermic one. So the foam will be at an elevated temperature after it is created, before it eventually cools down to room temperature. In addition, the blowing agent composition often acts as an insulator, so it will retain the heat of the reaction even longer after the reaction has completed. The heat distribution in the foam is non-uniform, and varies over time. An infrared imaging device, such as an IR camera, can detect the differences in temperature that are present in the foam, as well as differences that may be observed in the heat distribution of the foam as it is produced, and as it cools.

When there are problems with the composition or process, they can lead to defects in the foam, such as changes in density, firmness, or the formation of holes, large cells or tears in the foam structure. Processing parameters and raw material ratios can have a large effect on the foam product quality. However, if there is a defect, it is often not noticed until long after production. By that time, the defect has likely affected a large amount of polyurethane foam product that must be discarded, recycled, or sold at a price that reflects its lower quality.

Many defects, including changes in density, firmness, or the formation of holes, large cells or tears in the foam structure can be detected through changes in temperature. For example, holes, large cells and tears are notably slightly warmer than the rest of the foam product immediately after its production. When viewed by an infrared imaging device, holes, large cells and tears are noticeable, even when the same defects are not noticeable by an optical camera, or the naked eye. Changes in density and firmness can be first detected through changes in temperature, or changes in the heat distribution in the foam, as detected by an IR camera.

Additionally, the IR and optical camera can be used for quality control, and the images and thermal information can be stored as part of the quality control process demonstrating a polyurethane foam product was made according to specifications.

Another defect that IR and optical cameras may be able to detect, include differences in foam density and compressive strength. As noted above, IR cameras can detect the presence of voids. IR cameras may likewise be used to detect changes in the foam which may appear as different temperatures, reflecting a different foam density. A warmer foam product may be caused by the presence of more blowing agent and less foam, which also would be a lower foam density. Conversely, a cooler temperature may indicate less blowing agent, and a higher foam density. Compressive strength is another property whose changes may be predicted by changes in temperature, or a temperature profile, as observed by an IR camera. For example, a hotter temperature reading from a foam product may be correlated with low compressive strength, and a cooler temperature reading may be correlated with high compressive strength.

Furthermore, IR cameras may be used to detect changes in blowoff: locations, amounts, timing, and the distribution of the blowoff across the bun. More blowoff from one location, and the lack of blowoff from another, may signal a quality problem where one part of the bun did not develop as anticipated. Blowoff that is observed emitting from the bun too quickly, or more blowoff than expected, may indicate a sub-optimal mixture of reactants, blowing agent and catalyst, resulting in using more raw materials than expected, or than is optimal for the product. An IR camera used to observe blowoff should be located at an angle where heat from the blowoff can be differentiated from the heat of the bun, preferably at an angle above the bun, but not directly above the bun, i.e., greater than zero degrees and less than 90 degrees, preferably between 30 and 60 degrees, as measured from the surface of the bun.

A machine learning algorithm may be trained using actual measurements as a training data set. The temperatures measured, and the temperature profiles observed, by the IR camera may be correlated with the presence of defects, and subsequent measurements of foam density, compressive strength, utilization of raw materials, and other product quality measurements. Furthermore, changes in the temperatures and temperature profiles that are observed, may be used to generate predictions of when defects are likely to occur. These correlations can be used to create machine learning models that play an active role in the quality control process.

In another embodiment, an IR or optical camera may be used to monitor the polyurethane foam after it is produced. On occasion, a fire may erupt in a polyurethane foam product after it has been produced. Such a fire may be detected by an IR camera that may notice changes in the temperature in the polyurethane foam. Such an earlier detection of a fire before it starts may act to reduce the damage such a fire may do, including to other polyurethane foam products that may be stored in the same area, as well as the storage itself. In this embodiment a process parameter could include activating a fire suppression or sprinkler system.

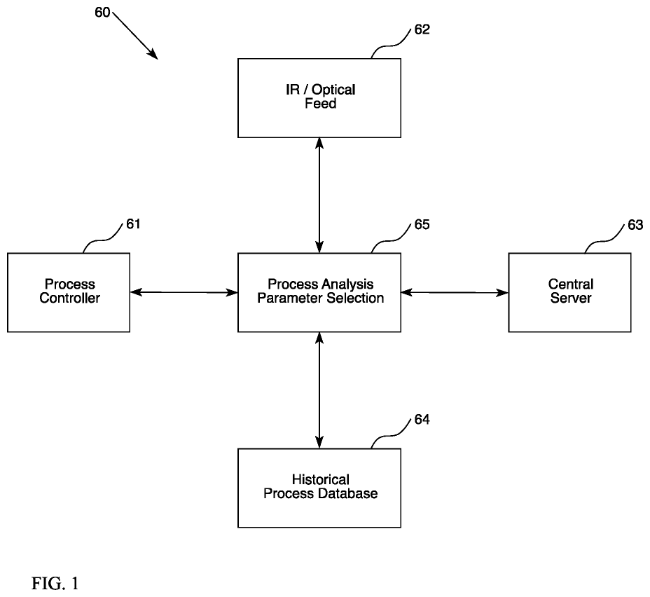

Referring to FIG. 1, a system 60 for analyzing and controlling a process to manufacture polyurethane foam is shown. The system 60 may include a process controller 61 in communication with a process analysis and parameter selection system 65 in order to provide the process controller with instructions to produce, or to stop producing, polyurethane foam, along with the process parameters used to produce polyurethane foam. The process parameters may include the flow of foam producing mixture through each of the control valves, the speed of the conveyor belts, and in some embodiments, the ratio of raw materials that feed into the outlets. The process controller 61 may be a computing device and may include a screen to display on at least one user interface for the user to interact with the process analysis and parameter selection system 65 to view a visible representation of the IR and/or optical IR feeds 62 and/or the process parameters, and control the process for producing the polyurethane foam.

The process analysis and parameter selection system 65 may communicate with a central server 63 in order to generate an additional and/or alternative process parameters to produce polyurethane foam, or to suggest to not produce any polyurethane foam, by accessing a list of orders or expected orders, and offering process parameters to produce polyurethane foam products to meet such orders. The process analysis and parameter selection system 65 and the central server 63 may be separate systems or may be parts of the same system.

The system 60 preferably comprises infrared (IR) and/or optical feed 62, wherein an infrared camera and/or an optical camera and/or other infrared or optical imaging device send(s) pictures or video of the polyurethane foam producing process to the process analysis and parameter selection system 65. Process analysis and parameter selection system 65 comprises data to determine if the images in IR/optical feed show the polyurethane foam in normal operation, or if it shows an image of a polyurethane foam that is producing off-spec material, or will likely produce off-spec material in the future. Alternatively, such data may be stored or learned, in historical process database 64 as discussed below.

One or more parts of system 60 may be located remotely, such as in a cloud computing environment. While the IR or optical cameras would be located where the foam is manufactured, the cameras may provide IR/Optical feed 62 remotely to a cloud environment, where central server 63 may be located, as well as historical process database 64. In other embodiments, process controller 61 and process analysis parameter selection 65 is also located in a cloud computing environment.

The still or video images provided to process analysis and parameter selection system 65 allow it to determine if there is a problem in the process, such as changes in temperature profiles that may indicate a larger problem, as well as any voids that may be seen, such as bubbles, tears and holes, and changes in the sizes of voids. As noted above, other defects that may be identified as requiring correction also include foam density and compressive strength. This allows process analysis and parameter selection system 65 to take early action to fix the problem, either before the quality of the polyurethane foam is impacted, or at least to minimize the downtime and waste associated with off-spec polyurethane foam. Examples of actions it can take include notifying a process operator, either directly or through process controller 61 or central server 63, and/or by sending alternate process parameters to process controller 61. Examples of alternate process parameters include slowing the process down until the outlet can be cleared, by restricting flow through the control valves and slowing down the conveyor. Further alternatives, if the process is so configured, may be to adjust the flow of the various raw materials which feed into the outlets to account for the one or more raw materials that may not be depositing enough into foam producing mixture. In other embodiments, the components of the mixture may be altered, such that the components are added in different amounts or different components are included in the mixture. Such corrective actions may allow for the polyurethane foam to be produced in a high quality manner until the clogged outlet(s) or raw material component feeds may be cleared or corrected.

To determine how to alter process parameters in case of changes as seen from the optical and/or IR feeds, process analysis and parameter selection system 65 may communicate with historical process database 64, which may have stored or learned solutions. The solutions comprise data associated with correcting defects identified by IR/optical feed 62, such as the formation of voids, or changes in foam density or compressive strength. Solutions may be learned by artificial intelligence or machine learning, to provide process parameters that may be used to correct for defects that may be seen or predicted by process analysis and parameter selection system 65 and IR/optical feed 62.

The historical process database 64 may include process parameter data associated with a previously-prepared polyurethane foam, including the IR/optical feeds and how they may have changed as a result of the process parameter changes. In this way, process analysis and parameter selection system 65 may analyze and consider IR or optical images of similar polyurethane foam products, and past actions to correct problems, to create the process parameters to correct the present problem. System 65 may also use characteristics of the IR or optical images to assign a grade or foam type to the foam. Historical process database 64 may be loaded with such data and information, and may also learn such data and information as the process experiences problems identified by process analysis and parameter selection system 65 and IR/optical feed 62.

The process analysis and parameter selection system 65 may comprise a predictive model associated with process parameter data along with IR and/or optical images to produce a polyurethane foam product, from historical process database 64. The predictive models may be generated using interpolations of existing data, database lookups of matches, multiple regression models of effects on altering process parameters in properties of polyurethane foams, including images taken after making such process alterations, or any number of machine learning and neural network algorithms. The predictive model generator may generate methods of correcting problems identified using images from the IR/optical feed, and associated process parameters.

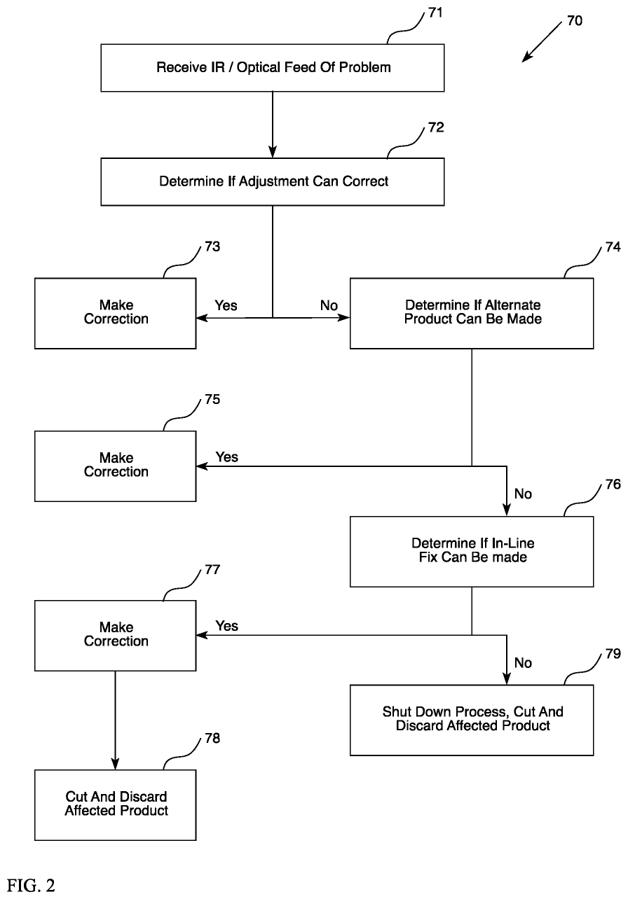

Referring to FIG. 2, a method 70 for rectifying a problem in the production of polyurethane foam is shown. In this method, the process analysis and parameter selection system receives an IR/optical feed showing there is a problem 71 in the production process for making polyurethane foam. The problem may be of a nature such that product defects such as voids are being produced in the polyurethane foam, or changes in temperature profiles are observed which may indicate a problem with foam density, and such defects are detected by the IR/optical feed. The process analysis and parameter selection system may also consider a trend showing a change in the images, which would indicate a problem will likely occur in the future.

The system then makes a determination 72 if an adjustment can correct the problem. To make this determination, the system may consider its historical process database, as well as a central server showing alternative products that may be made. From data in the system and/or in the historical process database, the system may consider previous or pre-loaded process changes and the resulting images from changes made to process parameters that were implemented to the system, or were pre-loaded to the system. If a change can be made, then the system directs the process controller to make a correction 73.

If a change cannot be made to correct the problem, then the system determines 74 if an alternate product can be made. In determining if an alternate product can be made, the system may communicate with a central server to review if there are other orders for polyurethane foam products, as well as the relative value of those orders, to determine if the most desirable course of action would be to change the process parameters to make the alternative product. An example of an alternative product is an order for a lower quality product, or a product that can be made with the present process impairment, as determined by an analysis of the IR/optical feed. If there is such a process change that can be made, the system makes the correction 75 to begin producing the new product.

In another non-limiting embodiment, the system may determine if an alternative product can be made, before determining if an adjustment can correct the defect. In this embodiment, the foam bun having a defect, but the foam is still within the product specifications of the alternative product, is separated so it may be sold as an alternative product. In addition, the system may predict certain performance characteristics of the polyurethane foam, based on the optical and/or IR camera inputs as described herein. The system may grade different products that are made by the process, or the same product having different degrees of defects, and separate the polyurethane foam products according to such differences. Furthermore, a performance rating system may be used based on the type and amount of defects observed, or based on the predicted performance of such polyurethane foam products. The system would than sort the different products according to the performance rating system.

If there is no such opportunity to produce an alternative product, then the system determines if an in-line fix can be made 76 to correct the problem. Examples of an in-line fix include changing the flow of one or more control valves to alter the amount of raw materials or foam producing mixture coming out of each valve, slowing one or more conveyors, and alerting an operator to clear solids from a particular outlet. If the correction can be made, the system then proceeds to make the correction 77, and cut and discard affected product 78. In the case of alerting a system operator, the correction may be to slow production to a minimum, to minimize product that would have to be discarded, and wait until the IR/optical feed shows an improved polyurethane foam being produced, such as after the operator has cleared the blocked outlet, and then the system would resume normal operation. As an alternative to discarding the affected product, it may be separated and used as a different grade product, if it should meet the specifications of the alternative grade.

If an in-line fix cannot be made to the process, then the system shuts the process down, alerts the operator, and cuts and discards any affected product 79. As mentioned above, such product may be separated and used as a different grade product.

In a further non-limiting embodiment, a computer program product for creating process parameters for producing polyurethane foam products includes at least one non-transitory computer readable medium including program instructions that, when executed by at least one processor, cause the at least one processor to execute any of the systems and methods described herein. The at least one processor may include the process analysis and parameter selection system 65 and/or the historical process database 64.

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicant reserve the right to amend the claims during prosecution to add features as variously described in this specification, and such amendments comply with the requirements of 35 U.S.C. § 112, first paragraph, and 35 U.S.C. § 132(a).

In addition, the following aspects are disclosed:

1. A method, system or computer program product for producing polyurethane foam, comprising:
depositing a foam producing mixture from outlets onto a trough or a conveyor;
producing the polyurethane foam having a top surface, from the foam producing mixture via an exothermic reaction;
cutting the polyurethane foam;
imaging the polyurethane foam (i) at or just after the outlets while the foam is being produced, (ii) above the top surface of the foam at an angle greater than zero to less than 90 degrees relative to the surface of the foam, or (iii) after the foam is cut but before it has cooled to room temperature, using an infrared or an optical imaging device, to capture an image of the polyurethane foam;
receiving a first signal comprising the captured image from the imaging device to a computing device;
determining, based on the captured image, if a defect that requires correction exists in the polyurethane foam; and
optionally, in response to determining that a defect requiring correction exists, modifying a process parameter in producing the polyurethane foam.

2. The method, system or computer program product of 1, wherein the foam producing mixture comprises a polyisocyanate, an isocyanate-reactive component and a blowing agent.

3. The method, system or computer program product of 1 or 2, wherein the imaging is at both (i) the outlets while the foam is being produced, and (ii) above the surface of the foam at an angle greater than zero to less than 90 degrees relative to the surface of the foam.

4. The method, system or computer program product of any of the preceding aspects, wherein the imaging is (ii) above the surface of the foam at an angle of 30-60 degrees relative to the surface of the foam.

5. The method, system or computer program product of any of the preceding aspects, wherein the infrared or optical imaging device is an infrared camera.

6. The method, system or computer program product of any of the preceding aspects, wherein the defect is selected from the group consisting of (i) a bubble, tear, hole or other void has appeared, (ii) the predicted foam density is too high, (iii) the predicted foam density is too low, (iv) the predicted firmness or compressive strength is too high, (v) the predicted firmness or compressive strength is too low, (vi) the raw material utilization is not optimal, and (vii) a portion of the bun has not developed as anticipated.

7. The method, system or computer program product of any of the preceding aspects, wherein the process parameter is selected from the group consisting of flow from an outlet, flow of raw material to an outlet, notifying a process operator, speed of producing the polyurethane foam, speed of a conveyor, components of the foam producing mixture, amounts of a component of the foam producing mixture and halt production.

8. The method, system or computer program product of any of the preceding aspects, further comprising the steps of:
determining the polyurethane foam does not meet quality standards, based on the captured image of the polyurethane foam;
cutting the polyurethane foam; and
separating the cut polyurethane foam that does not meet quality standards.

9. The method, system or computer program product of any of the preceding aspects, further comprising the steps of:
displaying on a user interface at least one of a process parameter and a visual representation of the captured image;
receiving on the user interface an input to change at least one process parameter; and
altering the at least one process parameter in response to the input from the user interface.

10. The method, system or computer program product of any of the preceding aspects, further comprising the steps of:
receiving one or more alternative polyurethane foam product specifications;
determining if, by altering at least one process parameter, the alternative polyurethane foam product can be produced according to the product specifications; and
altering at least one process parameter to produce the alternative polyurethane foam product according to the product specifications.

11. The method, system or computer program product of any of the preceding aspects, wherein in response to determining that a defect requiring correction has appeared, modifying a process parameter in producing the polyurethane foam, comprises:
receiving, with at least one processor, at least one of: (a) data associated with a previously-stored solution to correcting the defect that has appeared in the polyurethane foam; or (b) data from a predictive model used to generate a solution to correcting the defect that has appeared in a polyurethane foam; and
altering at least one process parameter in response to the data received by the at least one processor.

12. The method, system or computer program product of any of the preceding aspects, further comprising the steps of:
receiving a second signal comprising a captured image from the imaging device to a computing device, after the process parameter has been modified; and
storing data associated with the first and second signals, and the modification of the process parameter in producing polyurethane foam, to the computing device.

13. The method, system or computer program product of any of the preceding aspects, further comprising the steps of:
storing the polyurethane foam at a location with either sprinklers or a fire suppression system;
monitoring the temperature of the polyurethane foam that is being stored by an IR camera; and
in response to detecting an elevated temperature of the polyurethane foam, activating the sprinklers or the fire suppression system.

1. A method for producing polyurethane foam, comprising:
depositing a foam producing mixture from outlets onto a trough or a conveyor;
producing the polyurethane foam having a top surface, from the foam producing mixture via an exothermic reaction;
cutting the polyurethane foam;
imaging the polyurethane foam (i) at or just after the outlets while the foam is being produced, (ii) above the top surface of the foam at an angle greater than zero to less than 90 degrees relative to the surface of the foam, or (iii) after the foam is cut but before it has cooled to room temperature, using an infrared or an optical imaging device, to capture an image of the polyurethane foam;
receiving a first signal comprising the captured image from the imaging device to a computing device;
determining, based on the captured image, if a defect that requires correction exists in the polyurethane foam; and
optionally, in response to determining that a defect requiring correction exists, modifying a process parameter in producing the polyurethane foam.

2.-7. (canceled)

8. The method of claim 1, further comprising the steps of:
determining the polyurethane foam does not meet quality standards, based on the captured image of the polyurethane foam;
cutting the polyurethane foam; and
separating the cut polyurethane foam that does not meet quality standards.

9. The method of claim 1, further comprising the steps of:
displaying on a user interface at least one of a process parameter and a visual representation of the captured image;
receiving on the user interface an input to change at least one process parameter; and
altering the at least one process parameter in response to the input from the user interface.

10. The method of claim 1, further comprising the steps of:
receiving one or more alternative polyurethane foam product specifications;
determining if, by altering at least one process parameter, the alternative polyurethane foam product can be produced according to the product specifications; and
altering at least one process parameter to produce the alternative polyurethane foam product according to the product specifications.

11. The method of claim 1, wherein in response to determining that a defect requiring correction has appeared, modifying a process parameter in producing the polyurethane foam, comprises:
receiving, with at least one processor, at least one of: (a) data associated with a previously-stored solution to correcting the defect that has appeared in the polyurethane foam; or (b) data from a predictive model used to generate a solution to correcting the defect that has appeared in a polyurethane foam; and
altering at least one process parameter in response to the data received by the at least one processor.

12. The method of claim 1, further comprising the steps of:
receiving a second signal comprising a captured image from the imaging device to a computing device, after the process parameter has been modified; and
storing data associated with the first and second signals, and the modification of the process parameter in producing polyurethane foam, to the computing device.

13. The method of claim 1, further comprising the steps of:
storing the polyurethane foam at a location with either sprinklers or a fire suppression system;
monitoring the temperature of the polyurethane foam that is being stored by an IR camera; and
in response to detecting an elevated temperature of the polyurethane foam, activating the sprinklers or the fire suppression system.

14. A system for producing polyurethane foam, comprising:
depositing a foam producing mixture from outlets onto a trough or a conveyor;
producing the polyurethane foam having a top surface, from the foam producing mixture via an exothermic reaction;
cutting the polyurethane foam;
imaging the polyurethane foam (i) at or just after the outlets while the foam is being produced, (ii) above the top surface of the foam at an angle greater than zero to less than 90 degrees relative to the surface of the foam, or (iii) after the foam is cut but before it has cooled to room temperature, using an infrared or an optical imaging device, to capture an image of the polyurethane foam;
receiving a first signal comprising the captured image from the imaging device to a computing device;
determining, based on the captured image, if a defect that requires correction exists in the polyurethane foam; and
optionally, in response to determining that a defect requiring correction exists, modifying a process parameter in producing the polyurethane foam.

15. The system of claim 14, wherein the foam producing mixture comprises a polyisocyanate, an isocyanate-reactive component and a blowing agent.

16. The system of claim 14, wherein the imaging is at both (i) the outlets while the foam is being produced, and (ii) above the surface of the foam at an angle greater than zero to less than 90 degrees relative to the surface of the foam.

17. The system of claim 14, wherein the imaging is (ii) above the surface of the foam at an angle of 30-60 degrees relative to the surface of the foam.

18. The system of claim 14, wherein the infrared or optical imaging device is an infrared camera.

19. The system of claim 14, wherein the defect is selected from the group consisting of (i) a bubble, tear, hole or other void has appeared, (ii) the predicted foam density is too high, (iii) the predicted foam density is too low, (iv) the predicted firmness or compressive strength is too high, (v) the predicted firmness or compressive strength is too low, (vi) the raw material utilization is not optimal, and (vii) a portion of the bun has not developed as anticipated.

20. The system of claim 14, wherein the process parameter is selected from the group consisting of flow from an outlet, flow of raw material to an outlet, notifying a process operator, speed of producing the polyurethane foam, speed of a conveyor, components of the foam producing mixture, amounts of a component of the foam producing mixture and halt production.

21. The system of claim 14, further comprising:
determining the polyurethane foam does not meet quality standards, based on the captured image of the polyurethane foam;
cutting the polyurethane foam; and
separating the cut polyurethane foam that does not meet quality standards.

22. The system of claim 14, further comprising:
displaying on a user interface at least one of a process parameter and a visual representation of the captured image;
receiving on the user interface an input to change at least one process parameter; and
altering the at least one process parameter in response to the input from the user interface.

23. The system of claim 14, further comprising:
receiving one or more alternative polyurethane foam product specifications;
determining if, by altering at least one process parameter, the alternative polyurethane foam product can be produced according to the product specifications; and
altering at least one process parameter to produce the alternative polyurethane foam product according to the product specifications.

24. The system of claim 14, wherein in response to determining that a defect requiring correction has appeared, modifying a process parameter in producing the polyurethane foam, comprises:
receiving, with at least one processor, at least one of: (a) data associated with a previously-stored solution to correcting the defect that has appeared in the polyurethane foam; or (b) data from a predictive model used to generate a solution to correcting the defect that has appeared in a polyurethane foam; and
altering at least one process parameter in response to the data received by the at least one processor.

25. The system of claim 14, further comprising:
receiving a second signal comprising a captured image from the imaging device to a computing device, after the process parameter has been modified; and
storing data associated with the first and second signals, and the modification of the process parameter in producing polyurethane foam, to the computing device.

26. The system of claim 14, further comprising:
storing the polyurethane foam at a location with either sprinklers or a fire suppression system;
monitoring the temperature of the polyurethane foam that is being stored by an IR camera; and
in response to detecting an elevated temperature of the polyurethane foam, activating the sprinklers or the fire suppression system.

27.-38. (canceled)
